(19) United States
(12) Patent Application Publication
(10) Pub. No.: US 2012/0084537 A1
(43) Pub. Date: Apr. 5, 2012

(54) SYSTEM AND METHOD FOR EXECUTION BASED FILTERING OF INSTRUCTIONS OF A PROCESSOR TO MANAGE DYNAMIC CODE OPTIMIZATION

(75) Inventors: Venkat R. Indukuru, Austin, TX (US); Alex Mericas, Austin, TX (US); Brian R. Mestan, Austin, TX (US); II Park, Seoul (KR)

(73) Assignee: International Business Machines Corporation, Armonk, NY (US)

(21) Appl. No.: 12/894,762

(22) Filed: Sep. 30, 2010

(51) Int. Cl. G06F 9/30

(52) U.S. Cl. 712/227; 712/E09.016

(57) ABSTRACT

A filter executing on a processor monitors instructions executing on the processor to identify instructions that will benefit from performance tuning. Filtering instructions before analysis for performance tuning reduces overhead by identifying candidates for performance tuning with low cost monitoring before expending resources on analysis so that only instructions that will have performance tuning are analyzed. Reducing overhead for performance tuning makes performance tuning practical in a dynamic optimization environment in which instructions and their effective addresses change over time.

### BACKGROUND OF THE INVENTION

1. Field of the Invention

The present invention relates in general to the field of processor dynamic code optimization, and more particularly to a system and method for filtering instructions of a processor to manage dynamic code optimization.

2. Description of the Related Art

Integrated circuits process information by executing instruction workloads with circuits formed in a substrate. In order to enhance the speed at which information is processed, integrated circuits sometimes include performance tuning of instruction workloads. Conventional performance tuning profiles software code instructions that execute on an integrated circuit processor by identifying instructions that are performed most frequently, typically using time-based techniques. For example, instructions are identified by effective addresses that take most of the cycles of the processor. Similar techniques support profiling for “expensive events” that consume processor resources, such as cache misses, branch mispredicts, table misses, etc. . . . . Tuning profilers operate by programming a threshold for a hardware event caused by specially marked instructions and countdown. Once the counter overflows, the tuning profiler issues an interrupt so that an interrupt handler can read a register that contains the specially marked instruction's effective address. Tuning profilers accumulate many samples to build histograms of instruction addresses that suffer from the event most frequently in order to allow a focus on instructions that tend to be most delinquent.

Conventional tuning profiler techniques are adequate for static performance analysis, however, processor designs are moving towards dynamic environments where compilers and software stacks reoptimize code at runtime. The overhead of hardware data collection and processing presents an important consideration for dynamic environments. In order to make a dynamic environment practical, the overhead that supports the dynamic environment cannot consume more resources than are gained by the use of the dynamic environment. Performance tuning in a dynamic environment consumes resources by attempting to track which hardware performs instructions as the environment is changed in an attempt to reoptimize code executing at the processor.

Dynamic optimization of code executing at a processor involves runtime profiling of code, gathering information from hardware, analyzing the information and optimizing the code on the fly. Dynamic profilers collect data and spend processor cycles processing the collected data to optimize the code. In order to make dynamic optimization worthwhile, the benefit of executing dynamically optimized code must outweigh the overhead costs of data collection and processing. One example is a dynamic code optimizer that identifies instructions that miss the L3 cache so that it can attempt to prefetch the data accessed by those instructions ahead of time. To accomplish this, a dynamic optimizer will instrument processor hardware to collect samples of instruction addresses that miss the L3 cache, with sampling of instructions used to reduce the overhead of gathering every L3 miss. The processor hardware issues an interrupt to deliver samples of L3 cache misses and the associated instruction effective address and data effective address for each miss to the dynamic optimizer. The dynamic optimizer builds a histogram of instruction addresses that suffer from the most L3 cache misses so that optimization focuses on these instructions. The histogram is analyzed for data access patterns of the instruction and loop heuristics to determine a way to prefetch data addresses ahead of load execution. Data processing and analysis for dynamic optimization can involve substantial overhead that quickly consumes resources saved by the dynamic optimization.

### SUMMARY OF THE INVENTION

Therefore, a need has arisen for a system and method which improves the efficiency of resources used in a dynamic environment for performance tuning of workloads.

In accordance with the present invention, a system and method are provided which substantially reduce the disadvantages and problems associated with previous methods and systems for performance tuning of workloads at a processor. Instructions are filtered by filter criteria to identify instruction effective addresses associated with delinquent performance events. A filter table counts events for each effective address that meets the filter criteria until a threshold is met. Instruction effective addresses that meet the threshold are assigned performance tuning.

More specifically, a filter executes on a processor integrated circuit to monitor instructions executed at the processor for predetermined filter criteria. Instructions that meet the filter criteria are tracked by incrementing a counter associated with the effective address of the instruction in a filter table when the criteria are met and decrementing the counter when the instruction executes but does not meet the filter criteria. If the counter meets a threshold, the instruction associated with the effective address is assigned for performance tuning Examples of filter criteria include L3 cache misses, unpredictable branches, L1 cache misses and mispredicted branches. Low overhead of the filter makes filtering to identify effective addresses for performance tuning a cost effective technique for use with processor that have a dynamic optimization environment.

The present invention provides a number of important technical advantages. One example of an important technical advantage is that performance tuning operates efficiently with dynamic optimization so that overhead associated with performance tuning does not consume more resources than are made available by dynamic optimization. Filtering of events by filter criteria helps to identify instructions and effective addresses which provide the greatest efficiency gain by performance tuning. Filtering takes advantage of the typical profile for complex commercial workloads wherein a small number of instructions are responsible for a majority of delinquent performance events. Filtering to identify performance events in need of performance tuning before analyzing the performance events helps to ensure that resources consumed for performance tuning will have an efficient payback.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an integrated circuit having a filter that identifies instructions for performance tuning; and

FIG. 2 depicts a flow diagram of a process for filtering instructions to identify effective addresses for performance tuning.

### DETAILED DESCRIPTION

A system and method provides performance tuning in a dynamic optimization environment by filtering instructions to identify instruction effective addresses that will benefit from performance tuning in terms of processing efficiency. Reduced overhead costs associated with filtering identifies candidates for performance tuning in an efficient manner so that the benefits provided by performance tuning are not consumed by overhead costs in a dynamic optimization environment in which instructions and effective addresses change over time.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

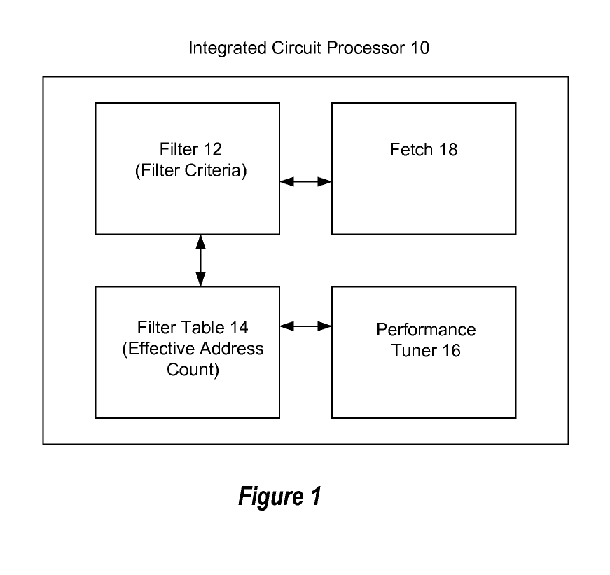

Referring now to FIG. 1, a block diagram depicts an integrated circuit 10 having a filter 12 that identifies instructions for performance tuning. Filter 12 is a data structure in hardware that records instruction effective addresses for events that meet a filter criteria in a filter table 14. Filter table 14 is updated by filter 12 based upon software configured filter criteria that is set to identify instructions that have potential for performance tuning by a performance tuner 16. Filter table 14 tracks the effective address of instructions based upon the address used by a fetch 18 and counts for each effective address the number of times the instruction completes in a manner that matches the filter criteria applied by filter 12. The count for a particular instruction reflects the relative frequency with which filter criteria are met by incrementing up when an instruction completes within the filter criteria and incrementing down when an instruction completes without meeting the filter criteria. When the count of a particular effective address crosses a threshold count, filter 12 issues an interrupt to have the effective address assigned to performance tuner 16 for subsequent analysis. Performance tuner 16 is assigned filtered effective addresses that a have a predetermined relative frequency of an event of interest that can benefit from performance tuning. For example, hardware events of interest for monitoring by filter criteria are relatively expensive events for processing overhead, such as cache misses, which are optimized by inserting prefetches. Some examples of filter criteria include:

1. L3 cache misses which resolve in local memory, with a latency of greater than 500 cycles and an effective address within a specified range;

2. Unpredictable branches in a specified effective address range;

3. L1 cache misses that resolve in L2 cache with latency greater than the expected L2 latency and that suffered a load hit store; and

4. Mispredicted branches.

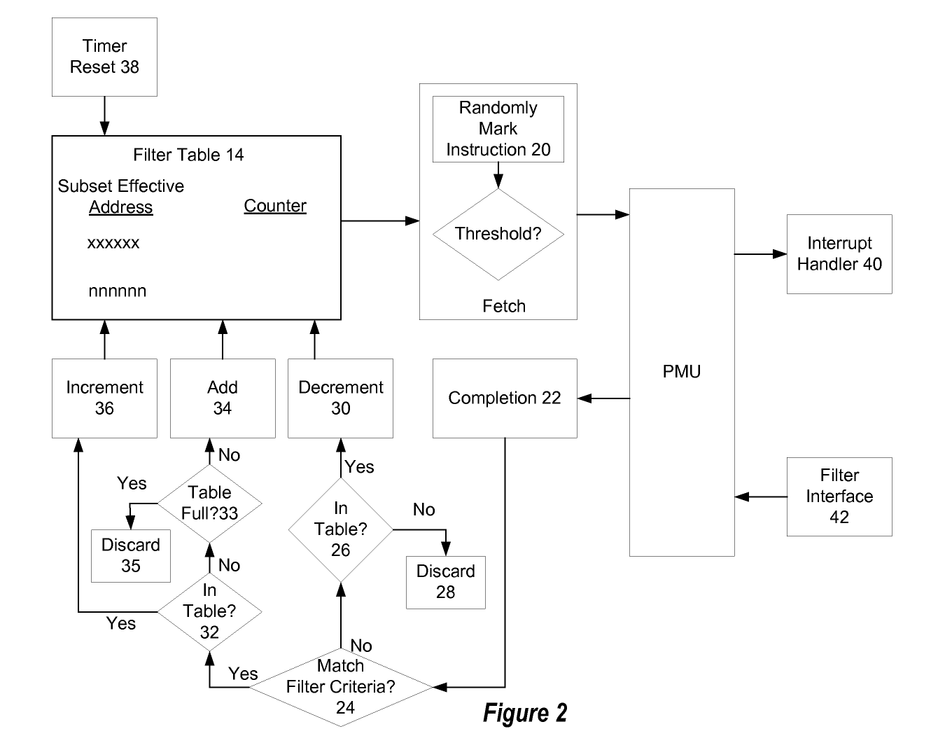

Referring now to FIG. 2, a flow diagram depicts a process for filtering instructions to identify effective addresses for performance tuning. The process begins at step 20 by randomly marking an instruction address at the instruction fetch stage to track execution of the instruction. At step 22, completion of the instruction having the marked instruction address is detected. At step 24, a comparison of the completion results for the marked instruction address against the filter criteria is made to determine if the instruction matches the filter criteria. If at step 24 the filter criteria is not matched, the process continues to step 26 to determine if the effective address is present in the filter table 14. If the effective address of the instruction is not in the filter table, the process continues to step 28 to discard the sample. If at step 26 the effective address is present in the filter table, the process continues to step 30 to decrement the counter for the effective address in the filter table 14. If at step 24 the instruction matches the filter criteria, the process continues to step 32 to determine if the effective address of the instruction is present in filter table 14. If the effective address is not present in filter table 14, the process continues to step 33 to determine if the table is full or can accept additional entries. If the table is not full, the process continues to step 34 to add the effective address to filter table 14 with a count of one. If at step 33 the filter table is full, the process continues to step 35 to discard the entry. If at step 32 the effective address is in the filter table, the process continues to step 36 to increment the counter for the effective address in filter table 14. Instructions are randomly marked at step 20 over time for comparison with filter criteria so that instruction addresses that match the filter criteria most frequently will increment a count up until a threshold is met. At step 38, a timer periodically resets the values of filter table 14 to zero so that data made irrelevant by dynamic optimization will not remain in filter table for an extend period.

Once a threshold is met for an effective address, the instruction associated with the effective address is indicated as one which will benefit from performance tuning. At step 20, if an instruction effective address is marked which meets a threshold in filter table 14, the instruction is tagged so that the full effective address is stored in a register and an interrupt is issued. An interrupt handler 40 detects that the interrupt issued for meeting the filter criteria threshold and so stores the register with the instruction effective address for later processing and returns to execution of the instruction. In order to avoid disruption of ongoing operations, performance tuner 16 performs performance tuning of the instruction associated with the effective address at a subsequent time. For example, if the filter criteria identifies instructions having L3 cache misses, performance tuner 16 includes a prefetch of data executed by the instruction to help obviate the L3 cache misses. Filtering of instructions for events identified by filter criteria helps to ensure that interrupts issued to assign performance tuning provides instructions that in effect are post processed and filtered to minimize sorting and analysis by the performance tuner, thereby reducing processing overhead associated with performance tuning. In a typical complex commercial workload, a small number of instructions will typically cause the majority delinquent performance events. In one performance analysis, a handful of instructions caused 95% of delinquent performance events. By filtering delinquent performance events to identify the instructions that cause most of the events, overhead for performance tuning is reduced to efficiently support performance tuning in a dynamically optimized environment in which instruction addresses change over time. A filter interface 42 allows filter criteria to be adjusted as desired for identifying instructions of interest for a particular software application.

Although the present invention has been described in detail, it should be understood that various changes, substitutions and alterations can be made hereto without departing from the spirit and scope of the invention as defined by the appended claims.

What is claimed is:

1. A method for filtering events at a processor to identify events for performance tuning, the method comprising:
executing plural instructions at the processor using dynamic optimization;
monitoring the plural instructions for predetermined filter criteria, each instruction having an effective address;
counting each of the plural instructions having the predetermined filter criteria;
detecting that one or more of the plural instructions meets a threshold; and
identifying each of the one or more detected plural instructions for performance tuning.

2. The method of claim 1 wherein counting each of the plural instructions further comprises:
incrementing a value in a filter table if the instruction meets the predetermined filter criteria at completion of the instruction; and
decrementing a value in a filter table if the instruction fails to meet the predetermined filter criteria at completion of the instruction.

3. The method of claim 2 wherein the filter table tracks instructions by the effective address of each instruction.

4. The method of claim 1 wherein the filter criteria comprises L3 cache misses.

5. The method of claim 1 wherein the filter criteria comprises unpredictable branches in a predetermined effective address range.

6. The method of claim 1 wherein the filter criteria comprises L1 cache misses that resolve in L2 cache.

7. The method of claim 1 wherein the filter criteria comprises mispredicted branches.

8. The method of claim 1 wherein performance tuning comprises prefetch of data for use in execution of the identified instruction.

9. An integrated circuit comprising:
a filter executing on the processor, the filter operable to monitor instructions fetched for execution and the completion of the instructions to identify instructions that meet predetermined filter criteria;
a filter table interfaced with the filter, the filter table operable to track a count for each instruction that meets the filter criteria by the effective address of the instruction; and
a performance tuner interfaced with the filter table and operable for performance tuning execution of instructions, the performance tuner providing performance tuning for instructions of the filter table having a count that meets a predetermined threshold.

10. The integrated circuit of claim 9 wherein the filter table tracks a count for each instruction by:
incrementing a value if the instruction meets the predetermined filter criteria at completion of the instruction; and
decrementing a value if the instruction fails to meet the predetermined filter criteria at completion of the instruction.

11. The integrated circuit of claim 9 wherein the filter criteria comprises L3 cache misses.

12. The integrated circuit of claim 9 wherein the filter criteria comprises unpredictable branches in a predetermined effective address range.

13. The integrated circuit of claim 9 wherein the filter criteria comprises L1 cache misses that resolve in L2 cache.

14. The integrated circuit of claim 9 wherein the filter criteria comprises mispredicted branches.

15. The integrated circuit of claim 9 wherein performance tuning comprises prefetch of data for use in execution of the identified instruction.

16. A method for dynamic optimization of instructions at a processor, the method comprising:
randomly marking plural instruction addresses at fetch of each of the plural instructions;
comparing completion of each instruction with a predetermined filter criteria;
incrementing a counter associated with each address having an instruction that meets the filter criteria; and
assigning instructions for performance tuning that have a counter of a predetermined threshold.

17. The method of claim 16 further comprising decrementing the counter associated with an address having an instruction that completes without meeting the filter criteria.

18. The method of claim 17 wherein the filter criteria comprises an L3 cache miss.

19. The method of claim 18 wherein the performance tuning comprises prefetch of data for use in execution by the instruction.

20. The method of claim 16 wherein assigning instructions for performance tuning further comprises storing an effective address of the instruction for subsequent processing without disrupting execution of the instruction.
